(19) United States
(12) Patent Application Publication
(10) Pub. No.: US 2005/0221019 A1
(43) Pub. Date: Oct. 6, 2005

(54) Method of improving the uniformity of a patterned resist on a photomask

(75) Inventors: Ki-Ho Baik, Pleasanton, CA (US); Mark A. Mueller, Menlo Park, CA (US); Stephen Osborne, Hayward, CA (US); Robert Dean, Castro Valley, CA (US); Homer Lem, Mountain View, CA (US)

Correspondence Address: Patent Counsel;APPLIED MATERIALS, INC., Legal Affairs Department, P.O. Box 450A, Santa Clara, CA, 95052, US

(73) Assignee: Applied Materials, Inc.

(21) Appl. No.: 10/817,140

(22) Filed: Apr. 2, 2004

(51) Int. Cl. G03C 5/00

(52) U.S. Cl. 427/487

(57) ABSTRACT

We have discovered that exposure of a photoresist on a photomask substrate to a vacuum after the photoresist has been exposed to imaging radiation results in improved critical dimension uniformity of the developed photoresist. Exposure of the imaged photoresist to vacuum is performed for a period of time sufficient to allow pattern critical dimensions to reach equilibrium across the photoresist. The vacuum treatment process of the invention is typically performed prior to the performance of a post-exposure bake process and prior to development of the photoresist. We have also discovered that exposure of a photoresist on a photomask substrate to a vacuum after the photoresist has been developed results in an improvement in the line edge roughness of pattern openings that have been formed through the photoresist layer thickness.

1. Field of the Invention

In general, the present invention relates to a method of producing a photomask (reticle) for use in the semiconductor industry. In particular, the invention pertains to a method for improving the critical dimension (CD) uniformity of a pattern in a photoresist which is used to transfer the pattern to a reticle.

2. Brief Description of the Background Art

Photoresists are used in microlithographic processes to produce patterned features required for device functioning in miniaturized electronic components, such as in the fabrication of semiconductor device structures. The miniaturized electronic device structure patterns are typically created using blanket radiation through a photomask to produce a pattern in a layer of photoresist material present on a semiconductor structure. There are instances, for specialized devices, where a pattern is directly written into a photoresist present on the semiconductor structure; however, due to the slow production speed of the direct write process, this is not commonly done.

A photomask or reticle which is used to enable rapid semiconductor device processing typically includes a thin layer of a radiation-blocking material (which is often a metal-containing material, such as a chrome-containing, molybdenum-containing, or tungsten-containing layer, for example) deposited on a glass or quartz plate. The thin layer of radiation-blocking material is patterned to contain a “hard copy” of the pattern to be recreated on the photoresist or photoresist/hard mask layer overlying a semiconductor structure. The patterning of the radiation-blocking layer of a reticle may be carried out using a number of different techniques. Due to the dimensional requirements of today's semiconductor structures, the pattern is typically generated using a direct write laser or e-beam to create a latent image in a photoresist for subsequent transfer to the radiation-blocking layer.

The reticle manufacturing process generally includes the following steps, when the initial substrate used to form the reticle is a silicon oxide-containing base layer having a layer of a metal-containing (typically chrome) mask material applied thereover: An inorganic antireflective coating (ARC) or an organic ARC, or a combination of inorganic and organic ARC layers, may be applied over the surface of the chrome mask material. A photoresist layer is then applied over the antireflective coating. The photoresist is typically an organic material which is dissolved in a solvent. The solution of photoresist is typically spin coated onto the surface of the photomask fabrication structure. Some of the solvent is removed during the spin coating operation. Residual solvent is subsequently removed by another means, typically by baking the fabrication structure, including the photoresist layer. This step is commonly referred to as a “post-apply bake” or PAB. The photoresist is then exposed to radiation (imaged), to produce a pattern in the photoresist layer, typically by a direct write process when the pattern includes dimensions which are less than about 0.4 μm or less. After exposure, the substrate including the photoresist layer is baked again. The second baking is typically referred to as a “post-exposure bake” or PEB. The photoresist is then developed, either using a dry process or a wet process, to create the pattern having openings through the photoresist layer thickness. Once the photoresist is “patterned” so that the pattern openings extend through the photoresist layer to the upper surface of an ARC layer, or to a surface beneath an ARC layer, the pattern in the patterned photoresist is transferred through the chrome-based mask layer and any remaining layers overlying the chrome layer, for example, typically by dry etching.

As described above, preparation of a photomask/reticle is a complicated process involving a number of interrelated steps which affect the critical dimensions of a pattern produced in the reticle and the uniformity of the pattern critical dimensions across the surface area of the reticle. Various efforts have been made within the industry to improve the reliability of manufacturing processes by improving individual process steps; however, when a production process involves a number of interrelated process steps, alteration of an individual process step may have an unexpected result on other interrelated process steps.

Commonly owned U.S. Pat. No. 6,703,169, to Scott Fuller et al., issued Mar. 9, 2004, and entitled “Method of Preparing Optically Imaged High Performance Photomasks”, discloses a state-of-the-art method of fabricating a photomask using optical radiation in the form of a direct write continuous wave laser. The claimed method comprises a series of steps including: applying an organic antireflection coating over a metal-containing layer; applying a chemically-amplified positive tone or negative tone DUV photoresist over the organic antireflection coating, to provide a photoresist-coated photomask substrate; post-apply baking the DUV photoresist over a temperature ranging from about 105° C. to about 115° C.; exposing a surface of the DUV photoresist to radiation from the direct write continuous wave laser, to provide a patterned photoresist across the photomask substrate; and post-exposure baking the DUV photoresist over a temperature ranging from about 70° C. to about 90° C. The post-apply bake process provides increased stability period for the photoresist-coated photomask substrate, where there is less than a 5 nm change in a 400 nm latent image critical dimension after a 6-hour time period. A combination of the post-apply bake process and the post-exposure bake process results in a uniform critical dimension of the patterned photoresist across the photomask substrate, where, for a 132-mm×132-mm active area, a critical dimension uniformity is ≦10 nm at 400 nm. The disclosure of U.S. Pat. No. 6,703,169 is hereby incorporated by reference in its entirety.

Commonly owned, co-pending U.S. application Ser. No. 10/768,919, of Christopher Dennis Bencher et al., filed Jan. 30, 2004, and entitled “Reticle Fabrication Using a Removable Hard Mask”, discloses a method of fabricating a reticle which provides improved critical dimension uniformity during fabrication of a reticle by minimizing the problem known as “photoresist pull-back”, which commonly occurs during etching of a chrome (or other radiation-blocking layer) on a reticle substrate. According to the method disclosed by Bencher et al., pattern transfer to the radiation-blocking layer of the reticle substrate essentially depends upon transfer from a hard mask rather than from a photoresist. In one embodiment, a hard mask material having anti-reflective properties is left on the surface of the chrome after etching of the chrome. Since the hard mask surface faces the surface of a photoresist on the semiconductor substrate which is patterned using the reticle, the presence of the proper anti-reflective properties in the hard mask can be used to reduce the amount of bounce-back of reflected radiation which occurs during blanket radiation imaging of the semiconductor photoresist through the reticle. In another embodiment, where a wet etch is used during fabrication of the reticle, the hard mask material (whether having anti-reflective properties or not) is removed to prevent contamination during the wet etch process. In this embodiment, when a plasma etchant used to remove the hard mask would also etch the reticle base substrate (which is typically quartz), a protective layer is applied to fill at least a portion of patterned openings through the chrome during removal of the hard mask. This prevents etching of the quartz at the bottom of the pattern openings during removal of the hard mask. The disclosure of U.S. application Ser. No. 10/768,919 is hereby incorporated by reference in its entirety.

As device dimensions become even smaller, further improvements in critical dimension uniformity of photomasks are needed. One commonly used means of improving photomask dimensional uniformity is by improving the dimensions of the patterned photoresist used to transfer the pattern to the photomask. The patterned photomask may be “descummed” using an oxygen plasma step, in which surface defects are removed from the photoresist pattern. Exposure to the oxygen plasma basically burns away a fixed amount of resist, which may help to smooth pattern line edges. Unfortunately, however, the descum oxygen plasma step typically reduces the resist dimensions by about 20-30 nm, making the descum process inapplicable to very small feature lithography.

It is readily apparent that it would be highly desirable to have a method of making a photomask where the uniformity of pattern critical dimensions is maintained across the entire surface of the photomask, even for features smaller than about 100 nm. To provide an improved photomask, it would be very advantageous to provide an improved patterned photoresist which can be used to transfer the pattern directly to the photomask, or to transfer the pattern to a hard mask which is subsequently used to pattern the photomask.

### SUMMARY OF THE INVENTION

We have discovered that application of a vacuum to a pattern irradiated (imaged) photoresist prior to development of the photoresist provides an improvement in critical dimension and uniformity in the developed photoresist. This improvement is translated into an improvement in the patterned photomask produced using the photoresist.

Typically, the application of vacuum is carried out prior to a post-exposure bake of the kind which is commonly performed on an imaged photoresist prior to development. Exposure of the photoresist on the photomask substrate to vacuum is performed for a period of time sufficient to allow the imaged pattern critical dimensions to reach equilibrium across the photoresist. The vacuum treatment process allows reaction by-product, water vapor, and solvents, for example, to desorb from the surface of the resist, improving critical dimension uniformity across the surface of the photoresist on the photomask substrate.

Typically, exposure of the pattern-imaged photoresist to vacuum is performed at a substrate temperature within the range of about 18° C. to about 60° C. (more typically, within the range of about 18° C. to about 40° C.), for a period of time within the range of about 10 minutes to about 70 hours (more typically, within the range of about 20 minutes to about 12 hours), at a process chamber pressure ranging from about 5×10⁻⁶ mTorr to about 5 mTorr. The pressure within the processing chamber during the vacuum treatment process may be limited by the capability of the particular apparatus in which the vacuum treatment process is performed. For example, when the vacuum treatment process is performed in an Applied Materials' MEBES™ QUADRA™ or MEBES™ eXara™ e-beam direct-write apparatus following the pattern writing process, the process chamber pressure during the vacuum treatment process is typically about 1×10⁻⁵ mTorr. When the vacuum treatment process is performed in an Applied Materials' TETRA™ etch system, the process chamber pressure during the vacuum treatment process may vary between about 10⁻⁷ Torr to about 10 mTorr, and was typically in the range of about 0.5 mTorr to about 1 mTorr during the experimentation described herein.

The time period required for pattern critical dimensions to reach equilibrium across the photoresist will depend upon the photoresist layer composition, and a combination of the temperature of the substrate/photoresist during the vacuum treatment process and the pressure (vacuum) applied. The minimal time period required for vacuum treatment of the photoresist on the photomask substrate will be the time period which provides no substantial change in pattern critical dimensions upon continued exposure of the irradiated photoresist to the vacuum.

Typically, the higher the temperature, the less time is required for pattern critical dimensions to reach equilibrium. However, the temperature is limited by the general stability of the photoresist material, which will depend on the particular photoresist material used. Also, typically the lower the pressure in the process chamber, the less time is required for vacuum treatment at a given temperature; however, the pressure used must ensure that deformation of the pattern does not occur and that the integrity of the photoresist is preserved. The amount of time required will also depend upon the condition of the photoresist prior to the vacuum treatment process, which will depend upon the type of photoresist used, the solvents in the photoresist, and the length of time of the post-apply bake (PAB) process. With minimal experimentation, one skilled in the art will be able to integrate the vacuum treatment step into an existing process for photomask production.

We have also discovered that exposure of the patterned (developed) photoresist to vacuum after development results in an improvement in the line edge roughness of pattern openings that have been formed through the photoresist layer thickness. This second vacuum treatment process is typically performed at a substrate temperature within the range of about 20° C. to about 60° C. for a period of time within the range of about 10 minutes to about 60 minutes, at a process chamber pressure ranging from about 5×10⁻⁶ mTorr to about 5 mTorr, where the time period is a function of the combination of temperature and pressure. In this second vacuum treatment, water vapor and solvents absorbed during the development process are desorbed from surfaces of the patterned resist, including the sidewalls and top resist surface. During desorption of the volatile components, the portion of the resist which is close to the surface is placed in tension. It is theorized, but not intended as a limitation, that this surface tension may allow for the “pulling together” of the surface, which may smooth out sidewall roughness. Since the bulk of the resist (deeper than within a few nanometers of the surface) is not in tension, lines and other features are not distorted.

The vacuum treatment processes of the invention work well whether the photoresist on the photomask substrate has been exposed to electron beam (e-beam) or optical radiation. Vacuum processing of photomask substrates according to the method of the invention typically improves the mean CD of the patterned photoresist by reducing the variation from the intended CD by about 3 nm or more, and by improving the uniformity (3-sigma) across a substrate surface by about 3-5 nm.

### BRIEF DESCRIPTION OF THE DRAWINGS

FIG. 1A shows a schematic cross-sectional view of a typical embodiment of a beginning structure 100 of a stack of materials used in the production of a photomask or reticle, when the pattern is transferred from the photoresist to the radiation-blocking layer of the mask without the use of a hard mask. The stack from bottom to top includes a substrate 102, which is typically selected from quartz, fluorinated quartz, borosilicate glass, or soda lime glass; a radiation-blocking layer 104, which is typically a metal-containing layer selected from a chromium, molybdenum silicide, or tungsten-containing layer, or combinations thereof (in the examples described herein, the radiation-blocking layer is essentially chrome); an inorganic ARC layer 105; an organic ARC layer 106; and a photoresist layer 108.

FIG. 1B shows the FIG. 1A structure 100 after development of the photoresist layer 108 to create a pattern of lines and spaces in the photoresist layer 108.

FIG. 2 is a graph 200 showing a global cross 1×CD uniformity (in nm) following vacuum treatment of the imaged photoresist prior to development, when the substrates were vacuum treated in a MEBES™ QUADRA™ imaging system (“RSB Vacuum Treated”) or were vacuum treated in an Applied Materials' TETRA™ etch chamber (“Tetra Vacuum Treated”), compared with the global CD uniformity for substrates which received no vacuum treatment following exposure of the photoresist to radiation (“No Vacuum”).

FIG. 3 is a graph 300 showing the decrease in developed photoresist thickness 302 as a function of time under vacuum 304, for photomask substrates which were vacuum treated in accordance with the present invention. The substrates were vacuum treated in an Applied Materials' TETRA™ etch chamber, at a temperature of approximately 45° C. and a process chamber pressure of approximately 0.5 mTorr.

FIG. 4 is a graph 400 showing local CD uniformity (in nm) before and after vacuum treatment of the developed photoresist. The substrates were vacuum treated in an Applied Materials' TETRA™ etch chamber for a period of 20 minutes, at a temperature of approximately 45° C. and a process chamber pressure of approximately 1 mTorr.

### DETAILED DESCRIPTION OF THE INVENTION

We have discovered a method of improving the patterning of a layer of photoresist which has been applied over a photomask substrate, The present method results in improved critical dimension uniformity of the developed photoresist. In general, the method comprises the steps of: a) post-apply baking the photoresist; b) exposing the photoresist to imaging radiation (typically direct-write radiation); c) exposing the imaged photoresist to a vacuum for a period of time sufficient to allow pattern critical dimensions to equilibrate across the photoresist, at a process chamber pressure ranging from about 5×10⁻⁶ mTorr to about 5 mTorr (typically, at a temperature ranging from about 20° C. to about 60° C., and for a time period ranging from about 10 minutes to about 70 hours); d) post-exposure baking the imaged photoresist; and e) developing the imaged photoresist to create a pattern having openings through the photoresist layer thickness.

The method may further comprise the additional step f) of exposing the developed photoresist to a vacuum subsequent to step e), at a substrate temperature within the range of about 20° C. to about 60° C. for a period of time within the range of about 10 minutes to about 60 minutes, at a process chamber pressure ranging from about 5×10⁻⁶ mTorr to about 5 mTorr. This second vacuum exposure step has been shown to improve the line edge roughness of pattern openings that have been formed through the photoresist layer thickness.

As a preface to the detailed description presented below, it should be noted that, as used in this specification and the appended claims, the singular forms “a”, “an”, and “the” include plural referents, unless the context clearly dictates otherwise.

I. Method of Patterning a Photoresist on a Photomask Substrate

All methods of patterning a photomask substrate may benefit from application of the present method. The method is particularly useful for DUV optical or e-beam patterning of a photomask when a chemically amplified photoresist is used to transfer the pattern to the photomask. The present Examples are for a REAP™ 200 chemically amplified photoresist (available from Tokyo Ohka Kogyo Co., Ltd. (TOK), Kawasaki, Japan), which is useful with both e-beam radiation and 248 nm optical radiation. However, the scope of the invention is not intended to be limited to this family of chemically amplified photoresists.

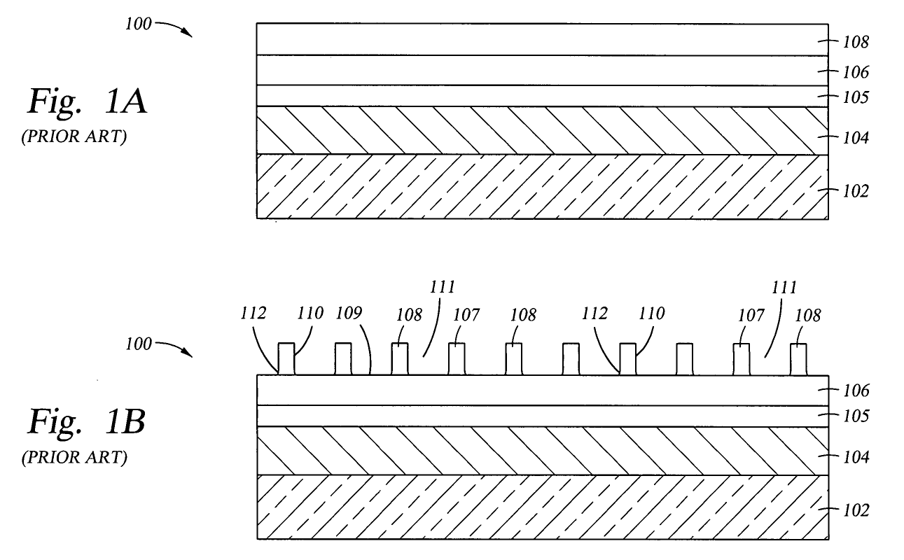

FIG. 1A shows one embodiment of a starting structure 100 used in the fabrication of example photomasks for experimental purposes herein. In this Example, starting structure 100 was a stack of layers (not shown to scale) which included, from top to bottom, a 3000 Å thick layer 108 of a chemically amplified photoresist, REAP™ 200 (available from TOK, Kawasaki, Japan); a 500 Å thick layer 106 of an organic ARC identified as XLT-BARC (available from Brewer Science, Inc., Rolla, Mo.); a 300 Å thick layer 105 of chromium oxynitride inorganic ARC; a 400 Å thick layer 104 of chrome mask material; and a silicon oxide-containing substrate 102.

The starting structure 100 shown in FIG. 1A can be formed using conventional deposition techniques known in the art of semiconductor manufacture. In particular, the photoresist layer 108 is typically applied to the surface of the organic ARC layer 106 using spin-on coating techniques. Some of the solvent or dispersion medium is removed during the spin coating operation.

Photoresist compositions of the kind suitable for use in the present method include: REAP™ 200 and EN24 (both available from TOK, Kawasaki, Japan); NEB 22 (available from Sumitomo Chemical Co., Ltd., Tokyo, Japan); and FEP 171 and FEN 270 (both available from Fuji-Hunt Electronics Company, Tokyo, Japan), by way of example and not by way of limitation.

After application of the photoresist layer, applicants performed a post-apply bake (PAB) process to remove residual solvent or dispersion medium. The post-apply bake process is typically performed at a temperature within the range of about 70° C. to about 150° C., for a time period of about 4 minutes to about 30 minutes. A particularly useful post-apply bake process is described in detail in U.S. Pat. No. 6,703,169, to Fuller et al., the disclosure of which is incorporated by reference in its entirety.

After post-apply bake, the photoresist was exposed to radiation (imaged), to produce a latent pattern in the photoresist layer, typically by a direct write process when the pattern includes dimensions which are less than about 0.4 μm. In the example embodiment, the minimum pattern dimension was about 60 nm. In the exposure process, the integrated circuit patterns were direct written onto the unpatterned photoresist 108 coated on a mask blank which included organic ARC layer 106, inorganic ARC layer 105, chrome-containing layer 104, and quartz layer 102 (described above). In a different embodiment, a hard mask (not shown) may be present between the photoresist 108 and the radiation-blocking layer 104.

The vacuum treatment process of the invention works well whether imaging of the photoresist is by e-beam radiation or by optical radiation. In the examples described herein, imaging of the photoresist was performed in a MEBES™ QUADRA™ electron beam mask patterning system (available from ETEC Systems, Inc., an Applied Materials company, with Applied Materials, Inc., having offices in Santa Clara, Calif.). Other imaging systems which can be used to practice the method described herein include, without limitation, the MEBES™ eXara™ electron beam mask patterning system, and the ALTA™ 3900 and ALTA™ 4300 laser beam mask patterning systems (all available from ETEC Systems, Inc.).

After imaging of the photoresist on the photomask substrate, the imaged photoresist was treated with a vacuum for a period of time sufficient to allow pattern critical dimensions to reach equilibrium across a given photoresist layer. The time period required for latent, imaged pattern critical dimensions to reach equilibrium across the photoresist will depend upon a combination of the temperature of the substrate during the vacuum treatment process and the pressure (vacuum) applied. After exposure of the imaged photoresist on the photomask substrate to vacuum for an optimum time period, no substantial change in pattern critical dimensions will occur upon continued exposure of the imaged photoresist to vacuum.

Typically, the higher the temperature, the less time is required for imaged pattern critical dimensions to reach equilibrium. However, the temperature is limited by the general stability of the photoresist material, which will depend on the particular photoresist material used. Also, typically the lower the pressure in the process chamber, the less time is required at a given temperature; however, the pressure used must ensure that deformation of the pattern does not occur and that the integrity of the photoresist is preserved. The amount of time required will also depend upon the condition of the photoresist prior to the vacuum treatment process, which will depend upon the type of photoresist used, the solvents in the photoresist, and the length of time of the post-apply bake (PAB) process. With minimal experimentation, one skilled in the art will be able to determine the amount of time required based on the particular apparatus that s/he is using and the particular process conditions under which that apparatus typically operates.

Vacuum treatment of photomask substrates in accordance with the methods of the invention can be performed in any suitable semiconductor processing apparatus which is capable of maintaining a process chamber pressure within the range of about 5×10⁻⁶ mTorr to about 5 mTorr. For example, an imaged photomask substrate may be vacuum treated in the exposure tool used for direct-write pattern irradiation of the photoresist. Alternatively, vacuum treatment of the imaged photomask substrates can be performed in other available equipment, for example, and not by way of limitation, in an Applied Materials' TETRA™ photomask etch system. By moving the photomask substrates to a different chamber for vacuum treatment following imaging, exposure tool throughput is not affected.

Typically, exposure of the imaged photoresist on the photomask substrate to vacuum is performed at a substrate temperature within the range of about 18° C. to about 60° C. (more typically, within the range of about 18° C. to about 40° C. Heating of the imaged resist on the photomask substrate to a temperature within the range of about 30° C. to about 60° C., and at a pressure ranging from about 0.1 mTorr to about 5 mTorr provides a substantial improvement in imaged resist pattern uniformity after a treatment.

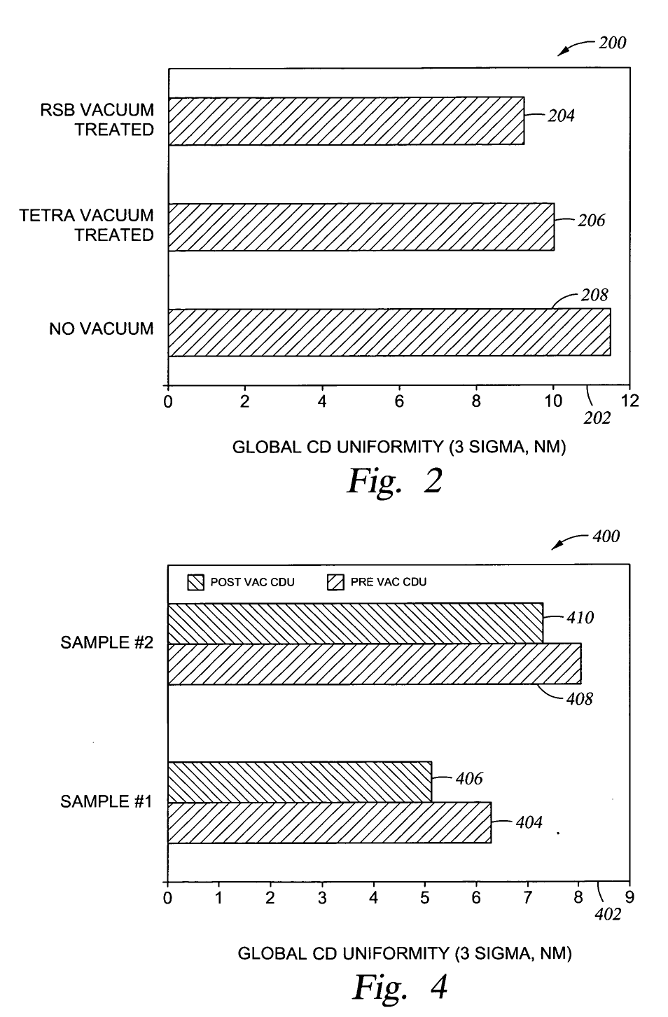

FIG. 2 is a graph 200 showing global cross 1×CD uniformity 202 (in nm) following vacuum treatment of the imaged photoresist prior to development, where the substrates were vacuum treated in the MEBES™ QUADRA™ imaging system (“RSB Vacuum Treated”) 204 or were vacuum treated in an Applied Materials' TETRA™ etch chamber (“Tetra Vacuum Treated”) 206, compared with the global CD uniformity for substrates which received no vacuum treatment following exposure of the photoresist to radiation (“No Vacuum”) 208. The RSB Vacuum substrates were vacuum treated in the pattern writing apparatus for a period of 5-9 hours at approximately 21-22° C.), at a process chamber pressure of approximately 1×10⁻⁵ mTorr. The Tetra Vacuum substrates were vacuum treated in a TETRA™ etcher for a period of 30 minutes at a temperature of approximately 30° C., at a process chamber pressure of approximately 1 mTorr The substrates which received no vacuum treatment were maintained at approximately 21-22° C.

After vacuum treatment, the photoresist was baked again. The second baking step is typically referred to as a “post-exposure bake” or PEB. Chemical reaction takes place between the time the pattern is written by irradiation upon the photoresist and the PEB, but after the PEB, the latent image is essentially fixed within the photoresist. The amount of time and the temperature of the substrate (i.e., the time/temperature profile) depends on the photoresist, and one skilled in the art can determine what this should be in view of the photoresist manufacturer's recommendations.

The post-exposure bake process is typically performed at a temperature within the range of about 70° C. to about 150° C., for a time period of about 4 minutes to about 30 minutes. A particularly useful post-exposure bake process is described in detail in U.S. Pat. No. 6,703,169, to Scott Fuller et al., the disclosure of which is incorporated by reference in its entirety.

After post-exposure bake, the photoresist is developed, either using a dry process or a wet process, to create the pattern having openings through the photoresist layer thickness. The photoresist in the present instance was developed using a puddle or spray develop process with a TMAH (2.38 weight % or 1.91 weight %) developer.

We have also discovered that exposure of the patterned (developed) photoresist to vacuum after development results in an improvement in the line edge roughness of pattern openings that have been formed through the photoresist layer thickness. Accordingly, after development of the photoresist, the method of the invention may further comprise an optional step of exposing the photoresist to a vacuum at a substrate temperature within the range of about 20° C. to about 60° C. for a period of time within the range of about 10 minutes to about 60 minutes, at a process chamber pressure ranging from about 5×10⁻⁶ mTorr to about 5 mTorr.

In this second vacuum treatment, water vapor and solvents absorbed during the development process are desorbed from surfaces of the patterned resist, including the sidewalls and top resist surface. During desorption of the volatile components, the portion of the resist which is close to the surface is placed in tension. It is theorized, but not intended as a limitation, that this surface tension may allow for the “pulling together” of the surface, which may smooth out sidewall roughness. Since the bulk of the resist (deeper than within a few nanometers of the surface) is not in tension, lines and other features are not distorted.

Proper timing of the vacuum treatment process allows for desorption of water vapor, solvents, and other by-products of previous processing steps from the surface of the resist, and also enables acids within the resist to diffuse in such a way as to reduce line edge roughness. Desorption of materials from the resist was found to slightly decrease the thickness of the photoresist layer. In addition, a slight shrinkage of pattern dimension was observed in the lateral (photomask plane) directions. Overall, vacuum processing of photomask substrates according to the method of the invention typically improves the mean CD of the patterned photoresist by reducing the variation of the intended CD by approximately 3 nm or more, and by improving the uniformity (3 sigma) across the wafer by about 3-5 nm. Our data also show an improvement in local CD uniformity.

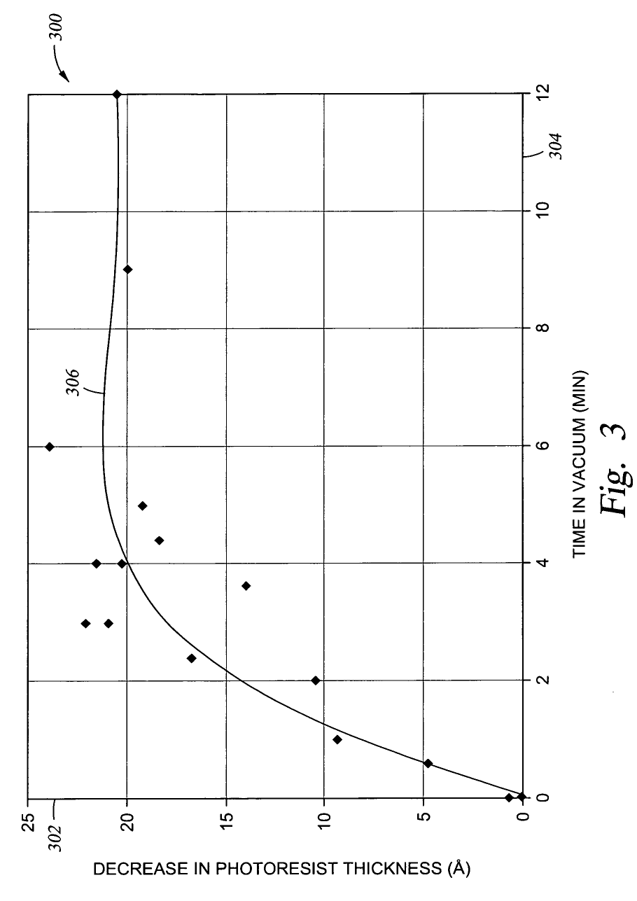

FIG. 3 is a graph 300 showing the decrease in photoresist thickness 302 for a developed photoresist as a function of time under vacuum 304 for photomask substrates which were vacuum treated in accordance with the present invention. The “curve” 306 of resist change is observed to “flatten out” (i.e., reach equilibrium) after about 20 minutes of vacuum treatment, after which no substantial change in pattern critical dimensions was observed upon continued exposure of the imaged photoresist to vacuum. The substrates were vacuum treated in an Applied Materials' TETRA™ etch chamber for a period of 20 minutes, at a temperature of approximately 45° C., and a process chamber pressure of approximately 0.5 mTorr.

The data presented graphically in FIG. 3 is for the REAP™ 200 photoresist. Data were also obtained for the EN24 photoresist (available from TOK, Kawasaki, Japan) and FEP 171 photoresist (available from Fuji-Hunt Electronics Company, Tokyo, Japan), under the same processing conditions described above for the REAP™ 200 photoresist. These data are presented in Table One, below.

TABLE 1
Decrease in Photoresist Thickness Following Post-Exposure
Vacuum Treatment

| Photoresist | Decrease in Photoresist Thickness (Å) |
|---|---|
| REAP ™ 200 | 20 |
| EN24 | 23 |
| FEP 171 | 17 |

FIG. 4 is a graph 400 showing local CD uniformity 402 (in nm) before (“PreVac CDU”) and after (“PostVac CDU”) vacuum treatment of the developed photoresist. The substrates were vacuum treated in an Applied Materials' TETRA™ etch chamber for 20 minutes, at a temperature of approximately 45° C. and a process chamber pressure of approximately 1 mTorr. Local CD variations for the y direction pre-vacuum treatment 404 and post-vacuum treatment 406 are shown for a first sample (“Sample # 1”). Local CD variations for the y direction pre-vacuum treatment 408 and post-vacuum treatment 410, are also shown for a second sample (“Sample # 2”). The two photomask substrate samples had different line-and-space patterns, which would explain the variation in CD uniformity between the two samples. The data shown in FIG. 4 are for a REAP™ photoresist (available from TOK, Kawasaki, Japan).

In addition to their use in the preparation of photomasks, the vacuum treatment processes described herein can be used to improve the quality of lithography in the patterning of semiconductor wafers. The vacuum treatment processes described herein can be applied to all wafer lithographic processes where critical dimension control is required, for all wavelengths of light utilized in wafer optical and e-beam lithography (G-line, i-line, KrF, ArF, 257 nm, for example, and not by way of limitation), plus other methods used for patterning resist on wafers, such as EUV. Line edge roughness is reduced, and critical dimension control is improved.

FIG. 1B shows a schematic cross-sectional view of the patterned photoresist layer 108 (prior to transfer of the pattern through underlying organic ARC layer 106, inorganic ARC layer 105, and chrome-containing layer 104), where the pattern was lines 107 and spaces 111, where the line width was about 30 nm to about 3 μm and the spacing between lines was about 30 nm to about 3 μm.

Once the photoresist has been developed and “patterned”, so that the pattern openings extend through the photoresist layer to the upper surface of an ARC layer, or to a surface beneath an ARC layer, subsequent processing steps are typically performed in order to transfer the pattern in the patterned photoresist through the chrome-based mask layer and any remaining layers overlying the chrome layer. These subsequent processing steps are summarized below and are also described in detail in U.S. Pat. No. 6,703,169, to Scott Fuller et al., which is incorporated by reference herein in its entirety. The mask fabrication process transforms the latent image created by the exposure of the photoresist into a permanent chrome image on the quartz substrate.

The pattern in the photoresist is typically transferred to the underlying photomask structure using a dry etch process, such as a plasma etching process. The chrome oxynitride (inorganic ARC)/chrome mask layer etch is typically performed using a plasma generated from a chlorine/oxygen/helium gas mixture. Typically, higher oxygen concentrations and lower pressures cause higher mean-to-target deviation and lower selectivities, while favoring better CD uniformity control. Plasma etch systems such as the TETRA™ etch system (available from Applied Materials, Inc., of Santa Clara, Calif.) may be used to provide excellent results. However, one skilled in the art will be able to optimize the process for other plasma etch apparatus.

Typically, the chrome layer is overetched beyond endpoint to clear residual chrome from all open regions. Generally, the overetch step is an extension of the chrome etch process described above. Longer overetch steps result in higher mean-to-target deviations. Chrome spot defect densities can be affected by the length of overetch, with lower defect densities for longer overetch processes.

After completion of the chrome layer etch, a strip and clean process is typically performed to remove any residual contaminants from the surface of the chrome layer. The strip process may be performed by heating sulfur peroxide to about 75° C. and applying the heated sulfur peroxide over the surface of the substrate plate. After treatment with sulfuric peroxide, the substrate plate is typically rinsed with CO₂-reionized or CO₂-sparged deionized water. After strip, the substrate plate is typically subjected to an acid clean using an industry standard 70:30 H₂SO₄/H₂O₂ solution, followed by another deionized water rinse. For example, the strip step may be performed on a Steag ASC 500 wet chemical processing station, available from STEAG-HAMMATECH® (Santa Clara, Calif.).

The above described preferred embodiments are not intended to limit the scope of the present invention, as one skilled in the art can, in view of the present disclosure, expand such embodiments to correspond with the subject matter of the invention claimed below.

1. In a method of patterning a layer of photoresist which has been applied over a photomask substrate and exposed to imaging radiation, the improvement comprising exposing said imaged photoresist to a vacuum for a period of time sufficient to allow pattern critical dimensions to equilibrate across said photoresist, at a process chamber pressure ranging from about 5×10⁻⁶ mTorr to about 5 mTorr.

2. A method in accordance with claim 1, wherein exposure of said imaged photoresist to said vacuum is performed at a substrate temperature within the range of about 18° C. to about 60° C., for a period of time within the range of about 10 minutes to about 70 hours.

3. A method in accordance with claim 2, wherein exposure of said imaged photoresist to said vacuum is performed at a substrate temperature within the range of about 18° C. to about 40° C., for a period of time within the range of about 20 minutes to about 12 hours.

4. A method in accordance with claim 1, wherein said radiation is e-beam radiation.

5. A method in accordance with claim 1, wherein said radiation is optical radiation.

6. A method in accordance with claim 1, wherein exposure of said imaged photoresist to said vacuum is performed prior to the performance of a post-exposure bake process.

7. A method in accordance with claim 1, wherein said exposure of said imaged photoresist to said vacuum is performed prior to development of said photoresist to create a pattern having openings through said photoresist layer thickness.

8. In a method of patterning a layer of photoresist which has been applied over a photomask substrate, exposed to imaging radiation, and developed to create a pattern having openings through said photoresist layer thickness, the improvement comprising exposing said developed photoresist to a vacuum at a substrate temperature within the range of about 20° C. to about 60° C. for a period of time within the range of about 10 minutes to about 60 minutes, at a process chamber pressure ranging from about 5×10⁻⁶ mTorr to about 5 mTorr.

9. A method of patterning a layer of photoresist which has been applied over a photomask substrate, comprising:
a) post-apply baking said photoresist;
b) exposing said photoresist to imaging radiation;
c) exposing said imaged photoresist to a vacuum for a period of time sufficient to allow pattern critical dimensions to equilibrate across said photoresist, at a process chamber pressure ranging from about 5×10⁻⁶ mTorr to about 5 mTorr;
d) post-exposure baking said imaged photoresist; and
e) developing said imaged photoresist to create a pattern having openings through said photoresist layer thickness.

10. A method in accordance with claim 9, wherein exposure of said imaged photoresist to said vacuum is performed at a substrate temperature within the range of about 18° C. to about 60° C., for a period of time within the range of about 10 minutes to about 70 hours.

11. A method in accordance with claim 10, wherein exposure of said imaged photoresist to said vacuum is performed at a substrate temperature within the range of about 18° C. to about 40° C., for a period of time within the range of about 20 minutes to about 12 hours.

12. A method in accordance with claim 9, wherein said radiation is e-beam radiation.

13. A method in accordance with claim 9, wherein said radiation is optical radiation.

14. A method in accordance with claim 9, wherein said method further includes the following step:
f) exposing said developed photoresist to a vacuum at a substrate temperature within the range of about 20° C. to about 60° C. for a period of time within the range of about 10 minutes to about 60 minutes, at a process chamber pressure ranging from about 5×10⁻⁶ mTorr to about 5 mTorr.

15. A method of patterning a layer of photoresist which has been applied over a photomask substrate, comprising:
a) post-apply baking said photoresist;
b) exposing said photoresist to imaging radiation;
c) post-exposure baking said imaged photoresist;
d) developing said imaged photoresist to create a pattern having openings through said photoresist layer thickness; and
e) exposing said developed photoresist to a vacuum at a substrate temperature within the range of about 20° C. to about 60° C. for a period of time within the range of about 10 minutes to about 60 minutes, at a process chamber pressure ranging from about 5×10⁻⁶ mTorr to about 5 mTorr.

16. A method in accordance with claim 15, wherein said imaging radiation is e-beam radiation.

17. A method in accordance with claim 15, wherein said imaging radiation is optical radiation.
